(19) United States
(12) Patent Application Publication
(10) Pub. No.: US 2023/0391509 A1
(43) Pub. Date: Dec. 7, 2023

(54) SACK FOR MAILING OR DUNNAGE

(71) Applicant: DS SMITH PLC, London (GB)

(72) Inventor: Russell TURNER, Redbrook, Monmouth (GB)

(21) Appl. No.: 18/249,498

(22) PCT Filed: Oct. 19, 2021
(86) PCT No.: PCT/EP2021/078908

§ 371 Date: Apr. 18, 2023

(30) Foreign Application Priority Data
Oct. 20, 2020 (GB) 2016631.0

(51) Int. Cl. B65D 27/00; B65D 81/03; B65D 65/46; B65D 30/08; B65D 75/26

(52) U.S. Cl. CPC B65D 27/005; B65D 81/03; B65D 65/466; B65D 31/02; B65D 75/26; B65D 2565/383; B65D 2581/053; B65D 2581/055

(57) ABSTRACT

A sack for mailing at least one item or for dunnage is provided. The sack is formed by two facing panels sealed along a perimeter. Each panel is at least one-ply and the ply has a layer of paper having a grammage from 35 to 450 g/m² and a film of an extruded or laminated polymer covering one face of the layer of paper.

The present invention relates to a sack for mailing one or more items or for dunnage, and the production method thereof.

### BACKGROUND ART

Padded mailing sacks are typically made from sack Kraft and Machine Glaze papers, both consisting of up to 95% virgin fibre, combined with single use plastic bubble wrap lining.

The materials of most of these sacks cannot be manually separated, making them not recyclable in the home waste stream.

Where they can be separated, substantial consumer responsibility and behavioral change is required.

Sustainable padded sacks do exist, but the price gap with plastic based ones is so large that a big environmental and financial commitment is required for an e-tailer to opt for these.

Unpadded mailing sacks can be paper-based, in which case they are typically manufactured from sack Kraft and Machine Glaze papers. Recycled fibre alternatives lack the rigidity and durability required.

Alternatively, unpadded mailing sacks can be produced from heavy gauge single use plastics, in which case the product is not recyclable at household level (kerbside) and tends to end up being incinerated or landfilled.

Accordingly, the sustainability of the materials hitherto used for mailing sacks is quite problematic.

Furthermore, the bubble wrap used for padded mailers is typically shipped in reels of bubble plastic and converted into a padded mailer or supplied in a pre-made fixed size padded format to the production or filling location. The economic and environmental costs of transporting trapped air can be substantial.

After insertion of the item(s) to be shipped, all known mailers have a certain amount of air in them that gets trapped around the item(s), which makes their volumetric cube/transportable size larger than necessary.

The filling of e-commerce mailers is often a manual process. Opening, filling and closure of the pre-made mailers can cause repetitive strain injury (RSI).

Hence, also the sustainability of the hitherto used production processes of mailing sacks is quite problematic.

In order to ship single or multiple items of various product types with different performance requirements, e-tailers require many different mailer sizes and formats. However, e-commerce machines producing sacks typically produce solely one type thereof: padded or unpadded, for mailing or for dunnage. As a result, the e-tailers require multiple machines and/or supplies of different formats (resulting in stock) to enable optimal shipper selection. Alternatively, they opt for a limited range of formats and standard sizes and accept a non-optimal fit for their products, resulting in excessive packaging and extra transportation costs/environmental footprint.

Hence, even the equipment presently used for the production of known mailers brings about several problems.

Finally, due to the diversity in the range of items dispatched through the e-commerce channel, e-tailers often revert to using over-sized generic cartons.

Consequently, many parcels of this kind need to be filled with dunnage to protect the shipped item from movement and damage. Dunnage systems typically use lots of paper, plastic pellets or inflated plastic bags of air.

Hence, the use of generic cartons in the e-commerce supply chain produces a lot of dunnage that is often not sustainable and needs to be additionally disposed of.

One object of the present invention is to overcome the above-captioned drawbacks of the prior art.

### SUMMARY OF THE INVENTION

According to the present invention, this object is achieved by means of a sack for mailing at least one item or for dunnage, formed by two facing panels sealed along the perimeter, wherein each panel is at least one-ply and wherein said ply includes a layer of paper having a grammage 35 to 450 g/m² and a film of an extruded or laminated polymer covering one face of said layer of paper.

Preferably, said polymer is biodegradable, and/or said paper is recycled, and/or said film has a thickness of 3 to 250 μm.

Advantageously, the sack of the invention has a substantially rectangular perimeter and one corner thereof is not completely sealed, so that the two panels are detached and manually peelable in correspondence of said corner.

According to an embodiment of mailing sack of the present invention, each panel is two-ply with an inner ply and an outer ply, wherein said inner ply includes a layer of paper having a grammage 35 to 450 g/m² and a film of an extruded or laminated polymer and said outer ply includes a layer of paper having a grammage 35 to 450 g/m² and a film of an extruded or laminated polymer, and wherein, preferably, a plurality of hermetically sealed individual air pockets are trapped between said inner and outer plies.

The above-disclosed mailing sack may be produced by a method comprising the steps of:
creating an envelope formed by two facing panels attached along one side,
inserting said at least one item between said two facing panels,
sealing said two facing panels along a perimeter end portion, and
extracting air trapped between said at least one item and said two facing panels.

According to a further embodiment of the present invention, a sack may be produced by a method comprising the steps of:
creating an envelope formed by two facing panels attached along one side,
inserting said at least one item between said two facing panels,
sealing said two facing panels along a perimeter end portion, and
blowing air between said at least one item and said two facing panels, so that a sack which is a dunnage pillow is created.

Each ply of the mailing sack according to the invention, is thus a combination of a preferably recycled lightweight paper, with a thin film of a preferably biodegradable extruded or laminated polymer. E.g., such polymer may be selected in the group consisting of modified polyvinyl alcohol-based polymers and polysaccharide-based biodegradable polymers with thermosetting behaviours and mixtures thereof.

This hybrid layered material has all the benefits of its constituents, because, on one hand, plastic renders it heat-sealable, air-tight, super-thin/light-weight, and malleable, and, on the other hand, paper renders it printable, somewhat water-resistant, low cost, kerbside recyclable and so on.

In sum, this hybrid material is extremely strong and resistant to puncture and tear. The unique biodegradability of the plastic used makes the material kerbside recyclable.

The total volume of material used can be significantly lower (i.e. at absolute minimum) compared to what would be required to achieve the same level of performance with a single-material alternative.

Importantly, the hybrid material can compete on price with single-use plastics and kraft paper solutions, enabling it to become mainstream.

The use of the above hybrid material allows in particular to manufacture three generic mailer or mailing sack options and one dunnage sack, each with different properties depending on their required performance, in a single system replacing multiple stand-alone operations.

This enables customers to produce different sack variations, in various pack sizes, on one single machine with fast switch-over times between formats.

The present invention thus allows the flexible creation of a range of fully sustainable, biodegradable padded and unpadded mailing sacks that provide optimal protection of the shipped items with the minimum packaging volume feasible in the e-commerce supply chain.

In particular, the above-captioned four generic options of sack are:
1) a 2-ply padded sack for items requiring a high degree of sustained cushioning protection and puncture- and moisture-resistance;
2) a 2-ply non-padded sack for items that require a high protection against puncture and moisture, but do not need cushioning;
3) a 1-ply sack for items requiring zero cushioning and a lower level of puncture and 35 moisture-resistance;
4) a 1-ply dunnage pillow filled with air, as a sustainable void fill option for e-commerce cartons.

### BRIEF DESCRIPTION OF THE DRAWINGS

Further advantages and features of the present invention will be apparent from the following detailed description, given by way of non-limiting example with reference to the appended drawings, in which:

FIG. 1 is a perspective view of a mailing sack according to the invention,

FIG. 2 is a schematic perspective view of an equipment for the production of the mailing sack of FIG. 1,

FIG. 3 is a section view along line of FIG. 2,

FIG. 4 is a perspective view of a detail of the mailing sack of FIG. 1,

FIG. 5 is a section view along line V-V of FIG. 1 during the packaging of an item to be shipped within the mailing sack of FIG. 1,

FIG. 6 is a section view along line VI-VI of FIG. 1 at the end of the packaging of the item to be shipped,

FIG. 7 is a section view corresponding to FIG. 5 of a second embodiment of a mailing sack according to the invention,

FIG. 8 is a section view corresponding to FIG. 5 of a third embodiment of a mailing sack according to the invention,

FIG. 9 is a section view corresponding to FIG. 6 of the third embodiment of a mailing sack according to the invention, and

FIG. 10 is a section view corresponding to FIG. 5 of a fourth embodiment of a dunnage sack according to the invention.

### DETAILED DESCRIPTION

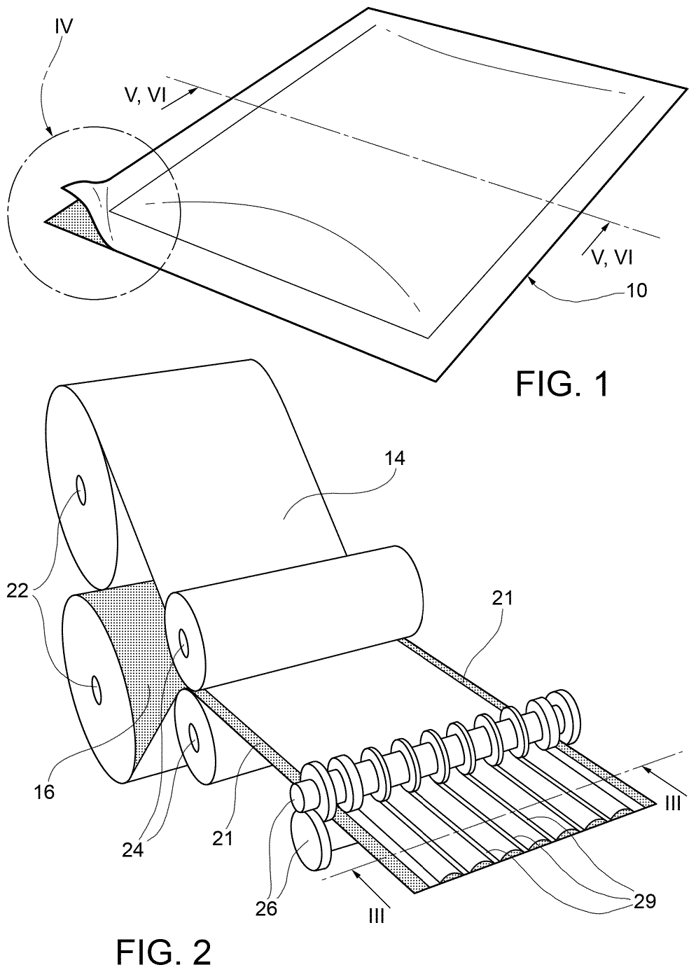

A mailing sack 10 for shipping at least one item 12 is formed (see FIGS. 1, 4, 5 and 6) by two facing panels which are joined, preferably by heat-sealing or alternatively by ultra-sound fusing, along the perimeter. The sack 10 has a substantially rectangular perimeter, but in not illustrated embodiments might have any different suitable shape.

Each panel is two-ply with an inner ply 14 and an outer ply 16. The inner ply 14 includes a layer 18 of preferably recycled paper having a grammage or 35 to 450 g/m² and a film 20 of a preferably biodegradable extruded or laminated polymer. The outer ply 16 includes a layer 18 of preferably recycled paper having a grammage 35 to 450 g/m² and a film 20 of a preferably biodegradable extruded or laminated polymer.

Hence, the two plies 14, 16 have a similar structure, but the outer ply 16 has a heavier paper layer 18, because it needs to have a higher durability, puncture- and water-resistance.

Furthermore, the outer ply 16 can optionally be made water-resistant by applying a barrier coating (varnish), and/or be printed upon, eliminating the need for labels with associated backing paper and offering the possibility for branded communication.

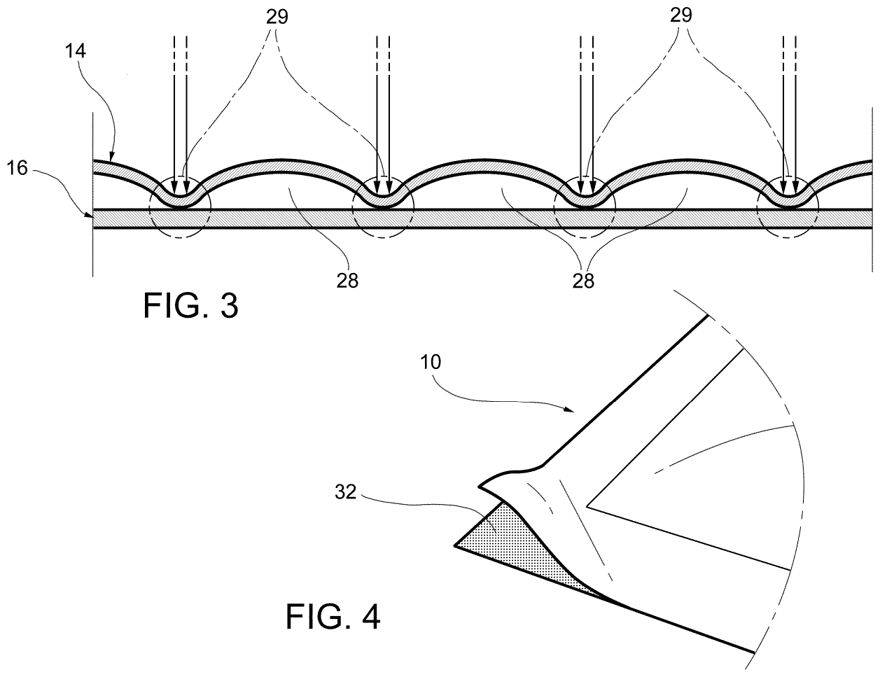

The mailing sack 10 is produced (FIG. 2) by unwinding from respective reels 22 the plies 14, 16, of which the outer ply 16 is slightly wider. Pressure rollers 24 draw together the plies 14, 16, whose plastic films 20 are in contact with each other, except narrow side strips 21 of the film 20 of the ply 16 that remain exposed to the external environment due to the different widths of the plies 14, 16. Successively, further shaped rollers 26 produce a plurality of hermetically sealed individual air pockets 28 trapped between the inner and outer plies 14, 16 (FIG. 3) which are attached to each other in correspondence of the separation regions 29 between adjacent air pockets 28. If necessary, additional air may be blown prior to the sealing of the pockets 28, whose number and size may be chosen as desired. Should one pocket 28 get punctured, the other pockets 28 will remain intact, so that the global cushioning function is maintained.

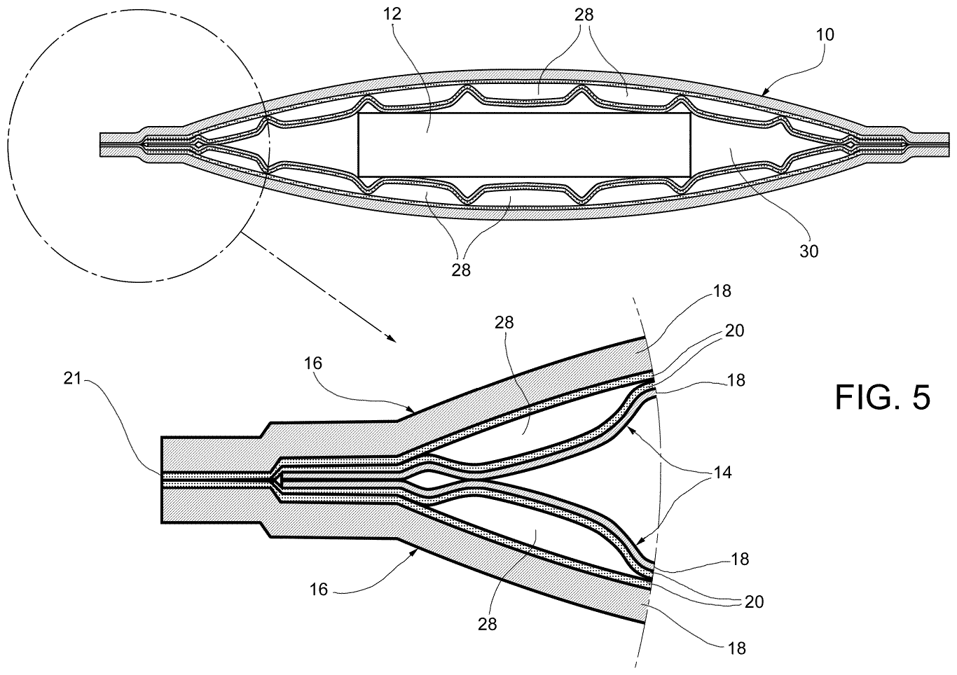

The joined together plies 14, 16 are then conventionally cut to the size requested for the sack 10 and folded, so that an envelope is formed by two facing panels attached along one side. The item 12 to be shipped is inserted within the envelope between the two facing panels, which are sealed along the side strips 21, respective lengths of which are adjacent to each other after folding (FIG. 5).

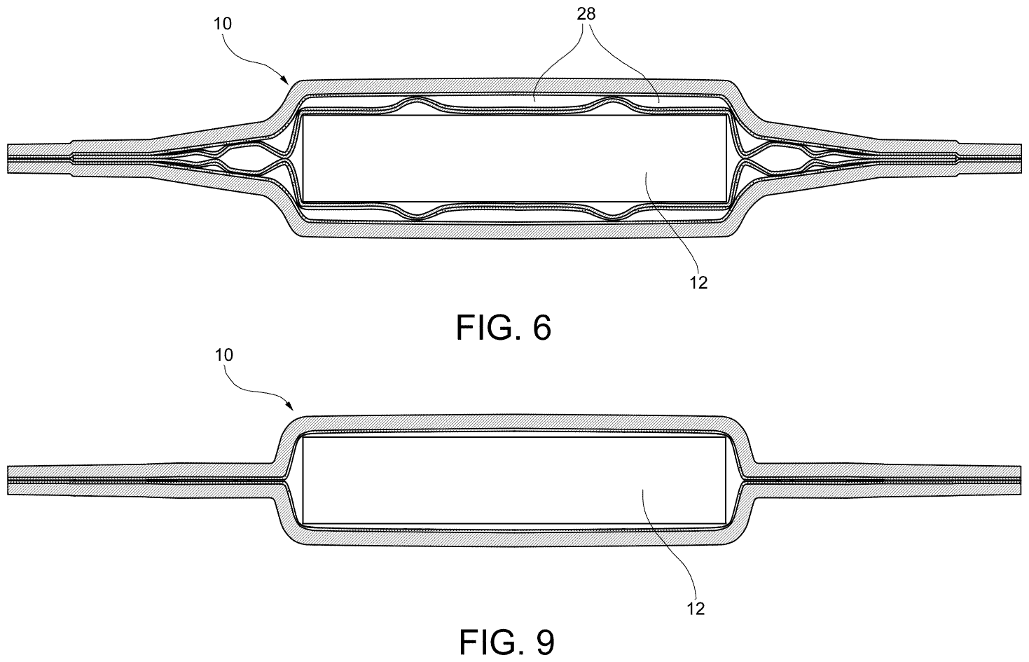

Prior to the final heat seal closure of the sack 10, excess air 30 trapped between the item 12 and the two facing panels is extracted (FIG. 6), creating the smallest possible volumetric size and rendering very flexible the sack 10 containing the item 12 to be shipped.

FIG. 4 illustrates that one corner 32 of the sack 10 is not completely sealed, so that the two panels are therein detached and manually peelable by the addressee of the shipment who can thus easily open the sack 10, when desired.

The mailing sack 10 does not need additional sealing tape with backing paper and so on, as any attempts of tampering will be immediately visible, and enables secondary use e.g. for food bags, and composting.

If the shipped item 12 needs to be returned, the sack 10 can be manually closed with tape and shipped back. Likewise, the sack 10 can be reused for the same purpose.

The hybrid material used for the plies 14, 16 of the mailing sack 10 allows for ease and simplicity in consumer recycling and eliminates non-recyclable multi stream formats, so that the sack 10, once used, can be disposed in the standard paper waste stream. The air pockets 28 can be easily deflated by cutting across the sack 10, in order to minimize the volume of this latter in view of disposal.

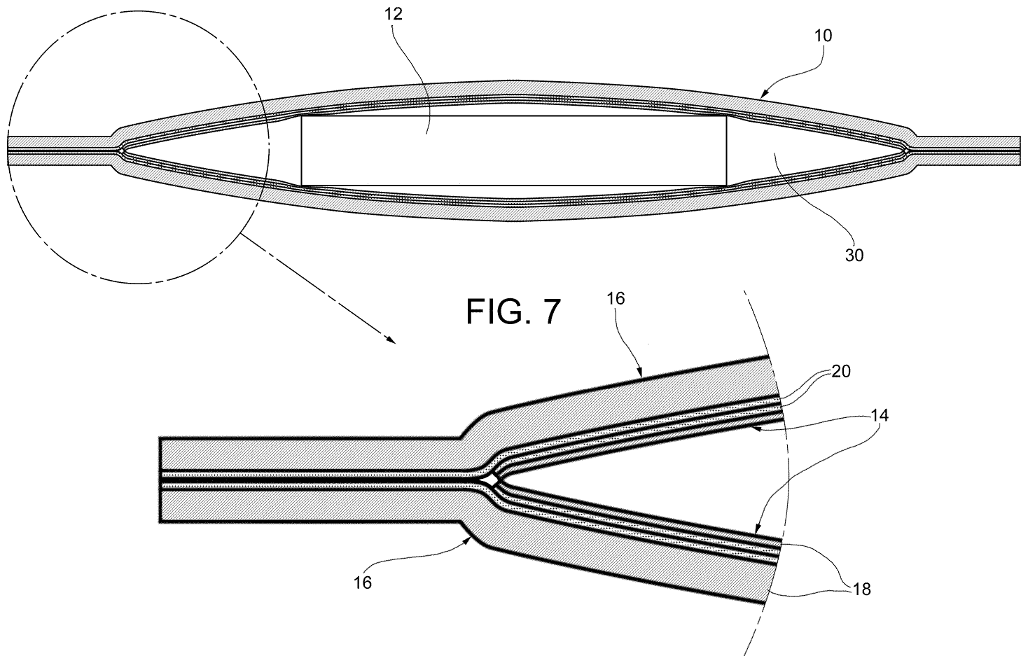

A second embodiment of the mailing sack of the present invention is illustrated by FIG. 7, wherein the same reference numbers are used to indicate components which are equal or equivalent to the ones disclosed with reference to the previous figures.

The only difference in respect of the mailing sack 10 of the previous embodiment is that no air pockets are created between the inner and outer plies 14, 16 of the facing panels.

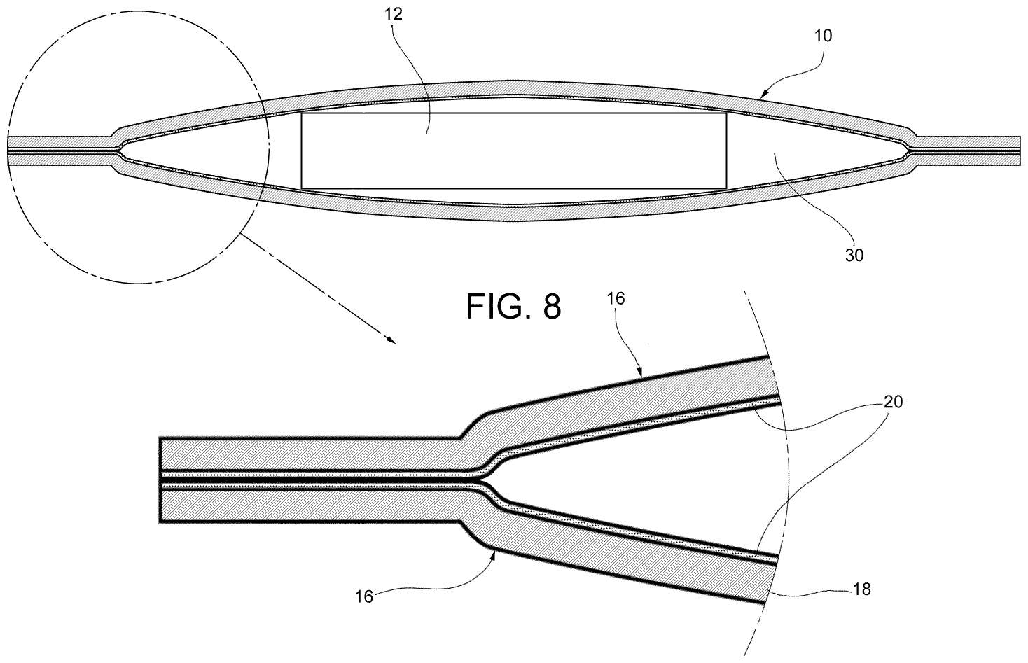

A third embodiment of the mailing sack of the present invention is illustrated by FIGS. 8 and 9, wherein the same reference numbers are used to indicate components which are equal or equivalent to the ones disclosed with reference to the previous figures.

The differences in respect of the mailing sacks 10 of the previous embodiments are that the facing panels have no inner ply 14 and thus no air pockets are created.

Panels constituted solely by the outer ply 16 allow a minimization of the volume by a 25 more extensive extraction of the air surrounding the item 12 prior to final closure sealing (FIG. 9), which air can be extracted also from the previously disclosed sacks. Alternatively, air can be blown into the above-disclosed sacks, if necessary.

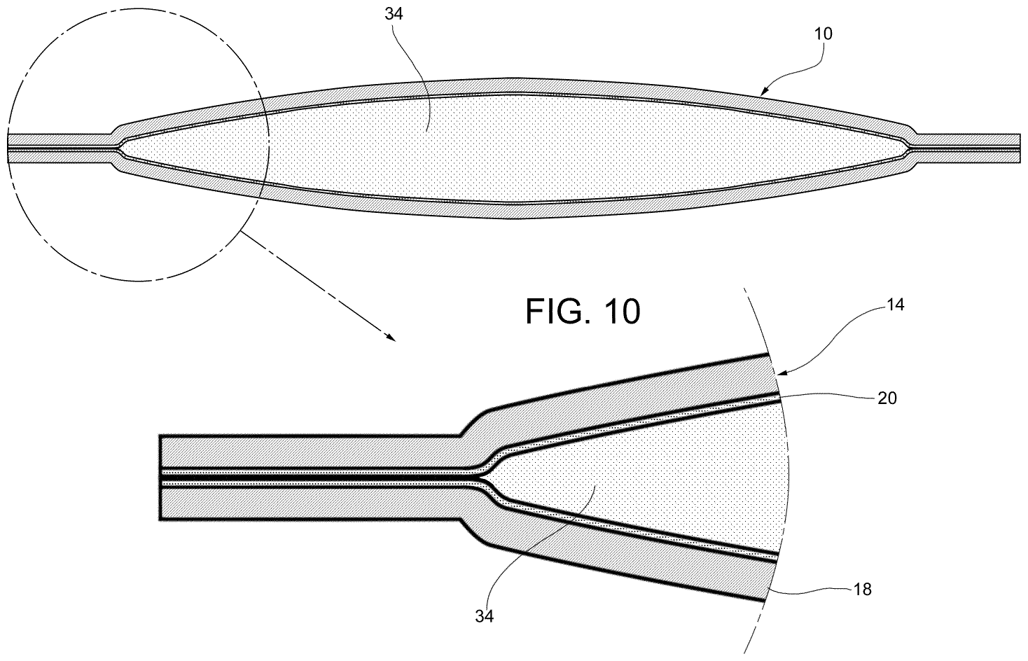

A fourth embodiment of sack of the present invention is illustrated by FIG. 10, wherein the same reference numbers are used to indicate components which are equal or equivalent to the ones disclosed with reference to the previous figures.

A first difference in respect of the mailing sacks 10 of the previous embodiments is that no outer ply 16 is used, so that the facing panels are constituted just by the inner ply 14.

Furthermore, prior to the final sealing of the sack 10, air is blown and trapped inside to create a dunnage pillow 34.

The air in the dunnage pillow 34 can be easily released by peeling a not completely closed corner 32 of the sack 10 as described above with reference to FIG. 4 and without needing any sharp object, unlike conventional air-filled plastic bags.

The above-disclosed different types of sacks 10 may be produced by using a single production line provided of reels 22 of hybrid materials suitable for the inner and outer plies 14, 16, respectively.

The user must solely input into a control unit the type, size and number of the desired sacks and the production line will be fed of the necessary materials by the relevant reel(s).

If material replenishment and/or maintenance is required, a notification will be given by the control unit. A splicing system ensures that, if necessary, reels 22 may be changed without interrupting the production. Vice versa, conventional commodities such as glue, backing paper, tape etc. are not required, so that the operation of the production line is quite simplified.

Naturally, the principles of the invention remaining the same, the details of construction and embodiments may be widely varied with respect to those described purely by way of example, without thereby departing from the claimed scope.

1-10. (canceled)

11. A sack for mailing at least one item or for dunnage, formed by two facing panels sealed along a perimeter,
wherein each panel is at least one-ply and wherein said ply includes a layer of paper having a grammage from 35 to 450 g/m² and a film of an extruded or laminated polymer covering one face of the layer of paper,
wherein each panel is two-ply with an inner ply and an outer ply, wherein the inner ply includes a layer of paper having a grammage from 35 to 450 g/m² and a film of an extruded or laminated polymer and the outer ply includes a layer of paper having a gram mage from 35 to 450 g/m² and a film of an extruded or laminated polymer, and
wherein a plurality of hermetically sealed individual air pockets is trapped between the inner and outer plies.

12. The sack of claim 11, wherein the extruded or laminated polymer is biodegradable.

13. The sack of claim 11, wherein the paper is recycled.

14. The sack of claim 11, wherein the film has a thickness ranging from 3 to 250 μm.

15. The sack of claim 11, wherein the sack has a substantially rectangular perimeter.

16. The sack of claim 11, wherein one corner of the sack is not completely sealed, so that the two facing panels are detached and manually peelable in correspondence of said corner.

17. A method for producing a sack for mailing at least one item or for dunnage according to claim 11, the method comprising:
creating an envelope formed by two facing panels attached along one side,
inserting the at least one item between the two facing panels,
sealing the two facing panels along a perimeter end portion, and
extracting air trapped between the at least one item and the two facing panels.
